(19) United States
(12) Patent Application Publication
(10) Pub. No.: US 2015/0237113 A1
(43) Pub. Date: Aug. 20, 2015

(54) METHOD AND SYSTEM FOR FILE TRANSMISSION

(71) Applicant: Tencent Technology (Shenzhen) Company Limited, Shenzhen (CN)

(72) Inventor: Gang LIU, Shenzhen (CN)

(21) Appl. No.: 14/702,357

(22) Filed: May 1, 2015

Related U.S. Application Data
(63) Continuation of application No. PCT/CN2013/084475, filed on Sep. 27, 2013.

(30) Foreign Application Priority Data
Nov. 6, 2012 (CN) 2012104385220

(51) Int. Cl. H04L 29/08; H04L 29/06

(52) U.S. Cl. CPC H04L 67/06; H04L 67/42; H04L 67/10

(57) ABSTRACT

A file transmission method and system relate to the technical field of communications networks, which can perform file resource sharing, so as to accelerate file transmission and publication, reduce time consumption, and save storage space. A browser upload plug-in at a client scans a to-be-uploaded file, acquires a unique identifier of the to-be-uploaded file, and sends the unique identifier to an instant-publishing management server. The instant-publishing management server determines, according to the unique identifier, whether the to-be-uploaded file corresponding to the unique identifier exists in a cloud storage server. The instant-publishing management server generates a download link of the to-be-uploaded file when the to-be-uploaded file corresponding to the unique identifier exists in the cloud storage server, and sends the download link of the to-be-uploaded file to the browser upload plug-in, so that a webmaster publishes the download link of the to-be-uploaded file on a website to provide a download service.

### RELATED APPLICATIONS

This application is a continuation application of PCT Patent Application No. PCT/CN2013/084475, entitled “METHOD AND APPARATUS FOR PLAYLIST SYNCHRONIZATION” filed on Sep. 27, 2013, which claims priority to Chinese Patent Application No. 2012104385220, filed with the Chinese Patent Office on Nov. 6, 2012 and entitled “METHOD AND SYSTEM FOR FILE TRANSMISSION”, both of which are incorporated herein by reference in their entirety.

### FIELD OF THE TECHNOLOGY

The present disclosure relates to the technical field of communications networks, and in particular, to a file transmission method and system.

### BACKGROUND OF THE DISCLOSURE

With the rapid development of network technologies, people are keen on sharing file content by using networks, and file sharing refers to providing online reading or downloading of a computer file by using a network in a certain range. Shared files may be provided by individuals and large-scale content service providers, and website webmasters are an important constituent part of an Internet ecosystem. Currently, when a webmaster publishes and shares a file, generally the webmaster needs to rent a file hosting server, and then collect files, and upload the files to a storage transit server. After a file is uploaded to the storage transit server, the file can be published. First a download link is generated according to the uploaded file, and the download link is published on a website of the webmaster as a portal for downloading and retrieving the file, and the webmaster operates content for download on the website by editing the content for download; in this way, a user can download a needed file from the storage transit server.

The existing technology at least has the following problems: a file on a webmaster website needs to be operated and managed by a webmaster, file resources published by different webmasters cannot be shared, and the file transmission and publication are low in speed and time-consuming; and storage space of the webmaster is limited, and each webmaster stores one separate copy for a same file, causing a waste of the storage space.

### SUMMARY

Embodiments of the present disclosure provide a file transmission method and system, which can perform file resource sharing, so as to accelerate file transmission and publication, reduce time consumption, and save storage space.

According to a first aspect of the present disclosure, a file transmission method between a client and an instant-publishing management server includes:

a browser upload plug-in at the client scanning a to-be-uploaded file, acquiring a unique identifier of the to-be-uploaded file, and sending the unique identifier to the instant-publishing management server;

the instant-publishing management server determining, according to the unique identifier, whether the to-be-uploaded file corresponding to the unique identifier exists in a cloud storage server; and

when the to-be-uploaded file corresponding to the unique identifier exists in the cloud storage server, the instant-publishing management server generating a download link of the to-be-uploaded file and sending the download link of the to-be-uploaded file to the browser upload plug-in, wherein a webmaster is configured to publish the download link of the to-be-uploaded file on a website to provide a download service.

With reference to the first aspect of the present disclosure, the step of the instant-publishing management server generating a download link of the to-be-uploaded file includes:

generating a download address of the to-be-uploaded file according to related information of the to-be-uploaded file, wherein the related information of the to-be-uploaded file comprises the unique identifier, a publication timestamp of the to-be-uploaded file, a user identifier of the webmaster that uploads the to-be-uploaded file, and verification information of the to-be-uploaded file.

With reference to the first aspect of the present disclosure, the instant-publishing management server acquires an upload interface address of an upload interface server when the to-be-uploaded file corresponding to the unique identifier does not exist in the cloud storage server, and sends the upload interface address to the browser upload plug-in; the browser upload plug-in uploads the to-be-uploaded file to the upload interface server according to the upload interface address; and the upload interface server stores the to-be-uploaded file in the cloud storage server, so as to provide a download service for a download client.

With reference to the first aspect of the present disclosure, the data stored in the cloud storage server further includes data downloaded by an offline download server.

With reference to the first aspect of the present disclosure, the offline download server is further configured to: receive a file identifier of a to-be-offline-downloaded file sent by an offline download task scheduling server; query, according to the file identifier, a database for a download link of the to-be-offline-downloaded file corresponding to the file identifier, and download the to-be-offline-downloaded file according to the download link; and store data of the to-be-offline-downloaded file in the cloud storage server when the to-be-offline-downloaded file is downloaded completely, and store a unique identifier of the to-be-offline-downloaded file in the database.

With reference to the first aspect of the present disclosure, the offline download server is further configured to report a download process of the to-be-downloaded file to an offline task management server, so that the download client views the offline download process.

With reference to the first aspect of the present disclosure, the offline task management server is configured to receive a task of a to-be-offline-downloaded file sent by the download client, and query whether a unique identifier of the to-be-offline-downloaded file exists in the database; send, to the download client when the unique identifier of the to-be-offline-downloaded file exists in the database, a message indicating that the to-be-offline-downloaded file has been downloaded completely, where the message includes an address used for retrieving data of the to-be-offline-downloaded file; and generate a file identifier for the task of the to-be-offline-downloaded file when the unique identifier of the to-be-offline-downloaded file does not exist in the database, send the file identifier and a download link of the to-be-offline-downloaded file to the database, and send an offline download task request message to the offline task scheduling server, where the offline download task request message includes the task of the to-be-offline-downloaded file and the file identifier.

According to a second aspect of the present disclosure, a file transmission system includes a client including a browser upload plug-in and an instant-publishing management server that is communicatively coupled to the client. The browser upload plug-in is configured to scan a to-be-uploaded file, acquire a unique identifier of the to-be-uploaded file, and send the unique identifier to an instant-publishing management server; and the instant-publishing management server is configured to determine, according to the unique identifier, whether the to-be-uploaded file corresponding to the unique identifier exists in a cloud storage server; and generate a download link of the to-be-uploaded file when the to-be-uploaded file corresponding to the unique identifier exists in the cloud storage server, and send the download link of the to-be-uploaded file to the browser upload plug-in, so that a webmaster publishes the download link of the to-be-uploaded file on a website to provide a download service.

With reference to the second aspect of the present disclosure, the instant-publishing management server is configured to generate a download address of the to-be-uploaded file according to related information of the to-be-uploaded file, where the related information of the to-be-uploaded file includes the unique identifier, a publication timestamp of the to-be-uploaded file, a user identifier of the webmaster that uploads the to-be-uploaded file, and verification information of the to-be-uploaded file.

With reference to the second aspect of the present disclosure, the instant-publishing management server is further configured to acquire an upload interface address of an upload interface server when the to-be-uploaded file corresponding to the unique identifier does not exist in the cloud storage server, and send the upload interface address to the browser upload plug-in; the browser upload plug-in is further configured to upload the to-be-uploaded file to the upload interface server according to the upload interface address; and the upload interface server is configured to store the to-be-uploaded file in the cloud storage server, so as to provide a download service for a download client.

With reference to the second aspect of the present disclosure, data stored in the cloud storage server further includes data downloaded by an offline download server.

With reference to the second aspect of the present disclosure, the offline download server is further configured to receive a file identifier of a to-be-offline-downloaded file sent by an offline download task scheduling server; query, according to the number of the to-be-offline-downloaded file, a database for a download link of the to-be-offline-downloaded file corresponding to the number of the to-be-offline-downloaded file, and download the to-be-offline-downloaded file according to the download link; and store data of the to-be-offline-downloaded file in the cloud storage server when the to-be-offline-downloaded file is downloaded completely, and store a unique identifier of the to-be-offline-downloaded file in the database.

With reference to the second aspect of the present disclosure, the offline download server is further configured to report a download process of the to-be-downloaded file to an offline task management server, so that the download client views the offline download process.

With reference to the second aspect of the present disclosure, the offline task management server is configured to: receive a task of a to-be-offline-downloaded file sent by the download client, and query whether a unique identifier of the to-be-offline-downloaded file exists in the database; send, to the download client, when the unique identifier of the to-be-offline-downloaded file exists in the database a message indicating that the to-be-offline-downloaded file has been downloaded completely, where the message includes an address used for retrieving data of the to-be-offline-downloaded file; and generate a file identifier for the task of the to-be-offline-downloaded file when the unique identifier of the to-be-offline-downloaded file does not exist in the database, send the file identifier and a download link of the to-be-offline-downloaded file to the database, and send an offline download task request message to the offline task scheduling server, where the offline download task request message includes the task of the to-be-offline-downloaded file and the file identifier.

With reference to the second aspect of the present disclosure, the database is configured to store file index information and file attribute information, where the file index information includes a mapping relationship between a file identifier and a download link corresponding to a file, and the file attribute information includes the file identifier, a unique identifier of the file, a size of the file, the download link of the file, and a download timestamp of the file.

The embodiments of the present disclosure provide a file transmission method and system, where a browser upload plug-in scans a to-be-uploaded file, acquires a unique identifier of the to-be-uploaded file, and sends the unique identifier to an instant-publishing management server; then, the instant-publishing management server determines, according to the unique identifier, whether the to-be-uploaded file corresponding to the unique identifier exists in a cloud storage server; and the instant-publishing management server generates a download link of the to-be-uploaded file when the to-be-uploaded file corresponding to the unique identifier exists in the cloud storage server, and sends the download link of the to-be-uploaded file to the browser upload plug-in, so that a webmaster publishes the download link of the to-be-uploaded file on a website to provide a download service. Compared with the existing technology in which when file transmission and publication are performed, a file on a webmaster website needs to be operated and managed by a webmaster, file resources published by different webmasters cannot be shared, and the file transmission and publication are low in speed and time-consuming; and a storage space of the webmaster is limited, and each webmaster stores one separate copy for a same file, causing a waste of the storage space, according to the solutions provided by the embodiments of the present disclosure, a file can be transmitted quickly by using the instant-publishing management server, and an uploaded file can be shared, so as to accelerate the file transmission and publication, and reduce time consumption; and the webmaster can directly publish the obtained download link on a website of the webmaster for users to download, without requiring the webmaster to store file data again, thereby saving the storage space.

### BRIEF DESCRIPTION OF THE DRAWINGS

To describe the technical solutions of the embodiments of the present disclosure or the existing technology more clearly, the following briefly introduces the accompanying drawings required for describing the embodiments or the existing technology. Apparently, the accompanying drawings in the following description show only some embodiments of the present disclosure, and a person of ordinary skill in the art may still derive other drawings from these accompanying drawings without creative efforts.

FIG. 1 is a flowchart of a file transmission method according to Embodiment 1 of the present disclosure;

FIG. 2 is a flowchart of another file transmission method according to Embodiment 1 of the present disclosure;

FIG. 3 is a flowchart of a method for an offline download server to download data according to Embodiment 1 of the present disclosure;

FIG. 4 is a schematic diagram of a file transmission system according to Embodiment 2 of the present disclosure; and

FIG. 5 is a schematic diagram of another file transmission system according to Embodiment 2 of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

### Embodiment 1

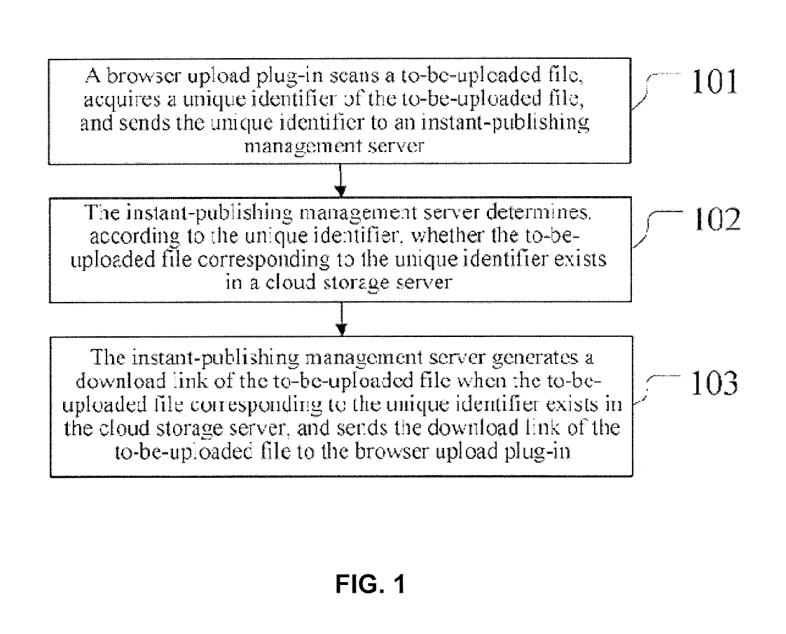

A file transmission method according to an embodiment of the present disclosure is described below with reference to FIG. 1. FIG. 1 shows a flowchart of a file transmission method between a client and an instant-publishing management server according to an embodiment of the present disclosure. As shown in FIG. 1, the method includes:

Step 101: A browser upload plug-in at the client scans a to-be-uploaded file, acquires a unique identifier of the to-be-uploaded file, and sends the unique identifier to an instant-publishing management server.

In this embodiment, an upload plug-in is installed on a browser, so that a file can be uploaded locally, and resumable upload of a file can also be supported, that is, when uploading of a file is interrupted, the rest part of the file can be uploaded continuously according to the uploaded part of the file after the browser gets online again, so that the file is uploaded completely.

In this embodiment, a webmaster network background may be logged in to by using the browser, and the number of times that a website related file is downloaded and a related traffic situation may be managed and viewed, so as to perform statistical processing.

In this embodiment, a hash value of the to-be-uploaded file may be acquired when the unique identifier of the to-be-uploaded file is acquired. A hash value is a unique and very compact value representation form of a piece of data. Certainly, the unique identifier of the to-be-uploaded file may also be represented by other expressions, and the representation of the unique identifier of the to-be-uploaded file is not limited in this embodiment of the present disclosure.

For ease of description, an example in which the unique identifier of the to-be-uploaded file is the hash value is used for description in this embodiment. Each file corresponds to one hash value, and the hash value may be obtained through calculation according to the file, for example, a unique identifier of a file may be calculated according to file content by using an algorithm such as a Secure Hash Algorithm (SHA) and a Message Digest Algorithm 5 (MD5); and generally, a hash value is of 20 bytes and uniquely identifies one file in the entire system, and different files correspond to different hash values.

Step 102: The instant-publishing management server determines, according to the hash value, whether the to-be-uploaded file corresponding to the hash value exists in a cloud storage server.

After the file is downloaded completely by a download client, an offline download server sends the hash value of the file to a database, and the database stores the hash value. Therefore, in this step, the instant-publishing management server may query, according to the hash value, the database for whether the to-be-uploaded file corresponding to the hash value exists in the cloud storage server. The database may store file index information and file attribute information, where the file index information may include a mapping relationship between a file identifier and a download link corresponding to a file, and the file attribute information may include the file identifier, a hash value of the file, a size of the file, the download link of the file, and a download timestamp of the file.

Step 103: The instant-publishing management server generates a download link of the to-be-uploaded file when the to-be-uploaded file corresponding to the hash value exists in the cloud storage server, and sends the download link of the to-be-uploaded file to the browser upload plug-in, so that a webmaster publishes the download link of the to-be-uploaded file on a website to provide a download service.

In some embodiments, the instant-publishing management server acquires an upload interface address of an upload interface server when the to-be-uploaded file corresponding to the hash value does not exist in the cloud storage server, and sends the upload interface address to the browser upload plug-in.

The browser upload plug-in uploads the to-be-uploaded file to the upload interface server according to the upload interface address.

The upload interface server stores the to-be-uploaded file in the cloud storage server, so as to provide a download service for a download client.

This embodiment of the present disclosure provides a file transmission method, where an instant-publishing management server queries a database based on a hash value of a to-be-uploaded file; and the instant-publishing management server generates a download link of the to-be-uploaded file when the to-be-uploaded file corresponding to the hash value exists in a cloud storage server, and sends the download link of the to-be-uploaded file to a browser upload plug-in, so that a webmaster publishes the download link of the to-be-uploaded file on a website to provide a download service. Therefore, by using this embodiment, a file transmission can be transmitted quickly, and an uploaded file can be shared, so as to accelerate file transmission and publication, and reduce time consumption; and the webmaster can directly publish the obtained download link on a website of the webmaster for users to download, without requiring the webmaster to store file data again, thereby saving storage space.

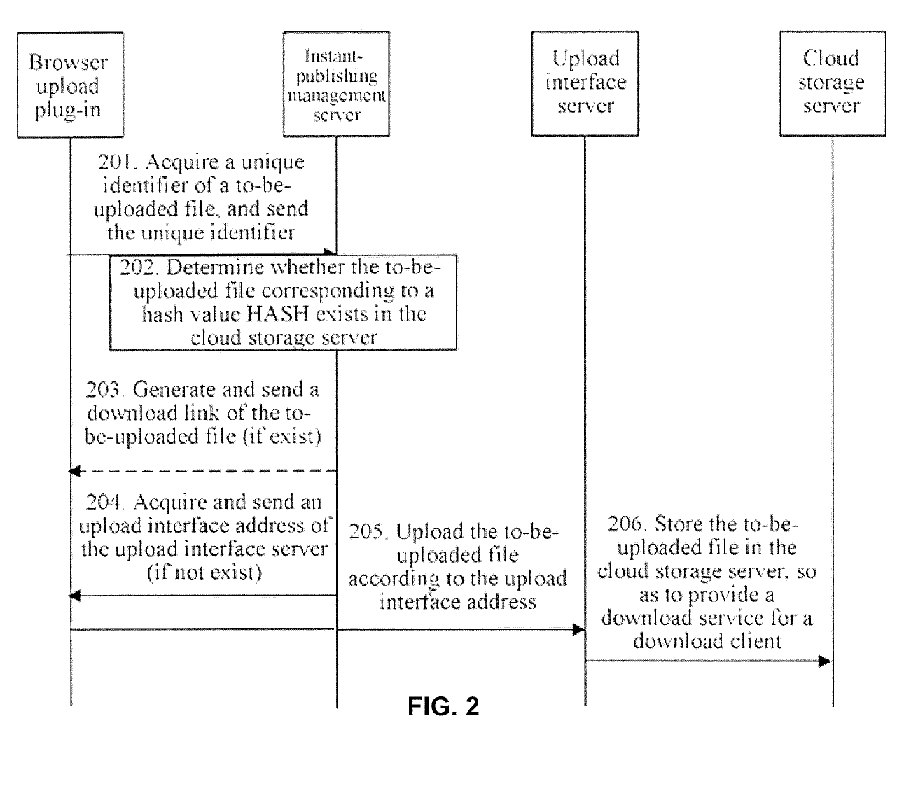

An embodiment of the present disclosure provides a file transmission method between a browser upload plug-in at a client and an instant-publishing management server. As shown in FIG. 2, the method includes:

Step 201: A browser upload plug-in scans a to-be-uploaded file, acquires a unique identifier of the to-be-uploaded file, and sends the unique identifier to an instant-publishing management server.

In this embodiment, an upload plug-in is installed on a browser at the client, so that a file can be uploaded locally, and resumable upload of a file can also be supported, that is, when uploading of a file is interrupted, the rest part of the file can be uploaded continuously according to the uploaded part of the file after the browser gets online again, so that the file is uploaded completely.

In this embodiment, a webmaster network background may be logged in to by using the browser, and the number of times that a website related file is downloaded and a related traffic situation may be managed and viewed, so as to perform statistical processing.

In this embodiment, a hash value of the to-be-uploaded file may be acquired when the unique identifier of the to-be-uploaded file is acquired. A hash value is a unique and very compact value representation form of a piece of data. Certainly, the unique identifier of the to-be-uploaded file may also be represented by other expressions, and the representation of the unique identifier of the to-be-uploaded file is not limited in this embodiment of the present disclosure.

For ease of description, an example in which the unique identifier of the to-be-uploaded file is the hash value is used for description in this embodiment. Each file corresponds to one hash value, and the hash value may be obtained through calculation according to the file, for example, a unique identifier of a file may be calculated according to file content by using an algorithm such as the SHA and the MD5; and generally, a hash value is of 20 bytes and uniquely identifies one file in the entire system, and different files correspond to different hash values.

Step 202: The instant-publishing management server determines, according to the hash value, whether the to-be-uploaded file corresponding to the hash value exists in a cloud storage server.

In this embodiment, the instant-publishing management server may provide a query service for file de-duplication before the browser upload plug-in uploads a file, that is, determine, according to the hash value of the to-be-uploaded file by querying a database, whether the to-be-uploaded file corresponding to the hash value exists in the cloud storage server. After the file is downloaded completely by a download client, an offline download server sends the hash value of the file to the database, and the database stores the hash value. Therefore, the instant-publishing management server may query, according to the hash value, the database for whether the to-be-uploaded file corresponding to the hash value exists in the cloud storage server. The database may store file index information and file attribute information, where the file index information may include a mapping relationship between a file identifier and a download link corresponding to a file, and the file attribute information may include the file identifier, a hash value of the file, a size of the file, the download link of the file, a download timestamp of the file, and the like.

In addition, specific data of the file, that is, content of the file, is stored by the cloud storage server. Cloud storage is a new concept extended and developed from the concept of cloud computing, and refers to a system in which a large number of various storage devices of different types are collected by using application software for collaboration work by using functions such as a cluster application, a grid technology or a distributed file system, so as to provide data storage and service access functions externally together. When computing and processing of a cloud computing system focus on storage and management of a large amount of data, the cloud computing system needs to be provided with a large number of storage devices, so that the cloud computing system turns to be a cloud storage system, and therefore, the cloud storage is a cloud computing system focusing on data storage and management. Therefore, the cloud storage server may provide infinite storage space, which can be expanded infinitely according to an actual storage capacity, thereby solving the problem of conventional hardware storage expansion in the existing technology. In addition, the cloud storage server may provide a plurality of backups, and has an automatic fault recovery function, thereby ensuring data reliability.

Step 203: The instant-publishing management server generates a download link of the to-be-uploaded file when the to-be-uploaded file corresponding to the hash value exists in the cloud storage server, and sends the download link of the to-be-uploaded file to the browser upload plug-in, so that a webmaster publishes the download link of the to-be-uploaded file on a website to provide a download service.

In some embodiments, in this step, the generating, by the instant-publishing management server, a download link of the to-be-uploaded file specifically includes: generating, by the instant-publishing management server, a download address of the to-be-uploaded file according to related information of the to-be-uploaded file, where the related information of the to-be-uploaded file may include the hash value, a publication timestamp of the to-be-uploaded file, a user identifier of the webmaster that uploads the to-be-uploaded file, verification information of the to-be-uploaded file, and the like. The verification information is generally generated by encrypting a field such as the hash value, the publication timestamp of the to-be-uploaded file, and the user identifier of the webmaster that uploads the to-be-uploaded file. Certainly, the verification information may also be generated in another manner, and the manner of generating the verification information is not limited in this embodiment.

The webmaster logs into a website thereof by using a browser, publishes a download link of a to-be-published file, that is, a dedicated link, on the website thereof; a user may acquire a download portal by browsing the website; support for the dedicated link is provided on the website; and the user may click the dedicated link to invoke dedicated download software of a corresponding download service provider, so as to download the to-be-published file.

Step 204: The instant-publishing management server acquires an upload interface address of an upload interface server when the to-be-uploaded file corresponding to the hash value does not exist in the cloud storage server, and sends the upload interface address to the browser upload plug-in.

It should be noted that, in FIG. 2, the execution of step 203 is indicated by using dashed lines, and certainly, the execution of step 204 may also be indicated by using dashed lines; herein, the dashed lines only indicate a selective relationship, that is, only step 203 is executed or steps 204, 205 and 206 are executed.

Step 205: The browser upload plug-in uploads the to-be-uploaded file to the upload interface server according to the upload interface address.

Step 206: The upload interface server stores the to-be-uploaded file in the cloud storage server, so as to provide a download service for a download client.

The upload interface server is configured to receive data of a file uploaded by the browser upload plug-in, and write the received data of the file into the cloud storage server.

The cloud storage server is configured to store the data of the file written by the upload interface server, and provide a service as a data source for the download client or a browser download plug-in to retrieve offline-downloaded data.

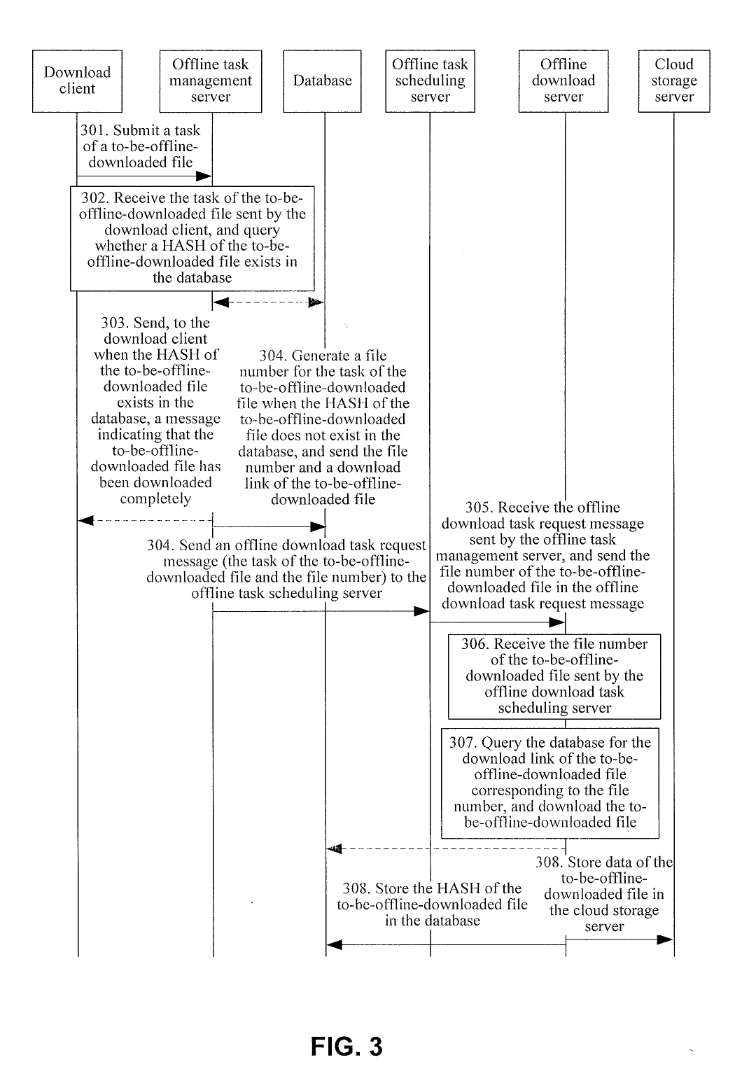

Further, the data stored in the cloud storage server may further include data downloaded by the offline download server. FIG. 3 shows an example of a process of downloading, by the offline download server, data, as shown in FIG. 3:

Step 301: The download client submits a task of a to-be-offline-downloaded file to an offline task management server.

It should be noted that, the download client may be installed in the browser, and a dedicated link download protocol is registered with an operating system during installation; therefore, a link for downloading a dedicated format, that is, a dedicated link, may be invoked on the browser. On a webmaster website, the dedicated link may be clicked to invoke dedicated download software of a corresponding download service provider for download.

The essence of offline download is that a server serving as a download tool perform download in advance in replacement of a user, for example, an offline download server is used to perform download in advance in replacement of a user. For example, a certain resource is a less popular resource and has a low download speed, so that a user needs to spend a lot of time for downloading; if the user uses the offline download technology, a server of a service provider may be used to download the resource in replacement of the user, and the user may turn off the download tool or computer, thereby saving time and reducing electric charge. After the offline download is completed, the user downloads the resource from the server serving as a download tool to a computer of a client at a high speed. The offline download may reduce much time for hang-up and waiting, and most importantly, bandwidth of the computer may be saved for other things.

Step 302: The offline task management server receives the task of the to-be-offline-downloaded file sent by the download client, and queries whether a hash value of the to-be-offline-downloaded file exists in the database.

After the file is downloaded completely, it is required to send the hash value of the file to the database for storage, so that when receiving a download task the next time, the offline task management server may determine, by querying a hash value of a file in the database, whether the file has been downloaded completely. Step 303 is performed for the file that has been downloaded completely, and step 304 is performed for the file that has not been downloaded. The execution of step 303 is indicated by using dashed lines in FIG. 3, and certainly, the execution of step 304 may also be indicated by using dashed lines, and herein, the dashed lines only indicate a selective relationship, that is, only one step of step 303 and step 304 is performed.

Step 303: Send, to the download client when the hash value of the to-be-offline-downloaded file exists in the database, a message indicating that the to-be-offline-downloaded file has been downloaded completely, where the message includes an address used for retrieving data of the to-be-offline-downloaded file.

When the hash value of the offline download task exists in the database, the download client may implement second download by using the address that is used for retrieving data of the to-be-offline-downloaded file and that is included in the message indicating that the to-be-offline-downloaded file has been downloaded completely, for example, the data of the corresponding file may be retrieved in a manner of Peer to Server & Peer (P2SP), and the cloud storage server is a data source of data storage.

The P2SP enables content to be transmitted on every terminal over the network. In addition to including Peer to Peer (P2P), the P2SP may further include Peer to Server, where “S” in the P2SP refers to a server. The P2SP effectively integrates the originally isolated server and mirror resource thereof as well as P2P resources, where the mirror resource refers to a backup resource. Based on a user to server and user mechanism, the P2SP is different from the P2P, and is also different from P2S; a P2SP download manner is actually a further extension of a P2P technology, which not only supports the P2P technology, but also integrates a server resource and the P2P resource by searching a database. When the user downloads a file, other resources may be searched for automatically, so as to select a suitable resource for speedup download, so that the P2SP has a great improvement in terms of download stability and download speed when compared with the conventional P2P. For example, current download software, such as the Thunder and the Xuanfeng, all uses the P2SP to download files.

In the P2SP technology, when a file is downloaded, data sources are classified into an original link of the file, and assistant resources of a P2P network and a third-party mirror, and then, a unique identifier hash value (for example, the MD5 or the SHA) of the file is used to cascade the file uniformly.

Step 304: The offline task management server generates a file identifier for task of the to-be-offline-downloaded file when the hash value of the to-be-offline-downloaded file does not exist in the database, sends the file identifier and the download link of the to-be-offline-downloaded file to the database, and sends an offline download task request message to the offline task scheduling server, where the offline download task request message includes the task of the to-be-offline-downloaded file and the file identifier.

The offline task management server may generate a unique number for each separate download task.

Step 305: The offline task scheduling server receives the offline download task request message sent by the offline task management server, and schedules the file identifier of the to-be-offline-downloaded file in the offline download task request message to an offline download server having an idle resource in an offline download server cluster.

The offline task scheduling server is further configured to receive load information reported by each offline download server in the offline download server cluster, and dynamically schedule, according to the load information of each offline download server, offline download tasks to different offline download servers to execute specific download tasks.

In addition, the offline task scheduling server may filter a same offline download task, that is, a same offline download task request only needs to be sent to the offline download server cluster once.

Step 306: The offline download server receives the file identifier of the to-be-offline-downloaded file sent by the offline download task scheduling server.

The offline download server is an offline download server having an idle resource in the current offline download server cluster.

Step 307: The offline download server queries, according to the file identifier, a database for a download link of the to-be-offline-downloaded file corresponding to the file identifier, and downloads the to-be-offline-downloaded file according to the download link.

Step 308: Store the data of the to-be-offline-downloaded file in the cloud storage server when the to-be-offline-downloaded file is downloaded completely, and store the hash value of the to-be-offline-downloaded file in the database.

The file can be shared and published by using a dedicated link, without the need of uploading the file by a webmaster by storing a file, especially a large file, downloaded by the offline download server in the cloud storage server, thereby reducing a time of uploading the file and reducing the occupation on the bandwidth.

Further, the offline download server is further configured to report a download process of the to-be-downloaded file to the offline task management server, so that the download client views the offline download process. Different users sending the same offline download task request may share offline download process information of the same offline download task.

The hash value of the to-be-offline-downloaded file is stored in the database, for the offline task management server to query when receiving a new offline download task, to determine whether an offline download task the same as the new offline download task has been completed, and when the offline download task the same as the new offline download task has been completed, file data directed to the offline download task can be retrieved instantly, thereby further reducing a time for the user to download the file.

This embodiment of the present disclosure provides a file transmission method, where an instant-publishing management server queries a database for a hash value of a to-be-uploaded file; and the instant-publishing management server generates a download link of the to-be-uploaded file when the to-be-uploaded file corresponding to the hash value exists in a cloud storage server, and sends the download link of the to-be-uploaded file to the browser upload plug-in, so that a webmaster publishes the download link of the to-be-uploaded file on a website to provide a download service. Therefore, by using this embodiment, a file transmission can be transmitted quickly, and an uploaded file can be shared, so as to accelerate file transmission and publication, and reduce time consumption; and the webmaster can directly publish the obtained download link on a website of the webmaster for users to download, without requiring the webmaster to store file data again, thereby saving storage space.

### Embodiment 2

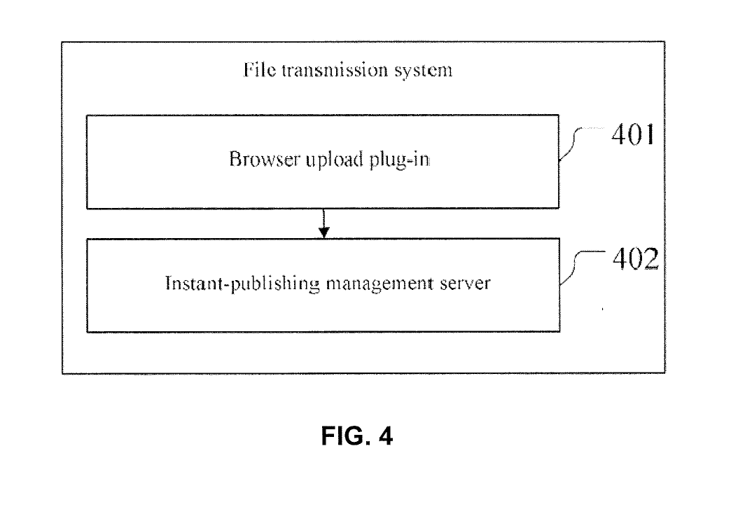

This embodiment of the present disclosure provides a file transmission system. As shown in FIG. 4, the system includes: a browser upload plug-in 401 and an instant-publishing management server 402.

The browser upload plug-in 401 is configured to scan a to-be-uploaded file, acquire a unique identifier of the to-be-uploaded file, and send the unique identifier to the instant-publishing management server 402.

An upload plug-in is installed on a browser, so that a file can be uploaded locally, and resumable upload of a file can also be supported, that is, when uploading of a file is interrupted, the rest part of the file can be uploaded continuously according to the uploaded part of the file after the browser gets online again, so that the file is uploaded completely.

In this embodiment, the browser upload plug-in 401 may acquire a hash value of the to-be-uploaded file when acquiring the unique identifier of the to-be-uploaded file. A hash value is a unique and very compact value representation form of a piece of data. Certainly, the unique identifier of the to-be-uploaded file may also be represented by other expressions, and the representation of the unique identifier of the to-be-uploaded file is not limited in this embodiment of the present disclosure.

For ease of description, an example in which the unique identifier of the to-be-uploaded file is the hash value is used for description in this embodiment. Each file corresponds to one hash value, and the hash value may be obtained through calculation according to the file, for example, a unique identifier of a file may be calculated according to file content by using an algorithm such as the SHA or the MD5; and generally, a hash value is of 20 bytes and uniquely identifies one file in the entire system, and different files correspond to different hash values.

The instant-publishing management server 402 is configured to determine, according to the hash value, whether the to-be-uploaded file corresponding to the hash value exists in a cloud storage server; and generate a download link of the to-be-uploaded file when the to-be-uploaded file corresponding to the hash value exists in the cloud storage server, and send the download link of the to-be-uploaded file to the browser upload plug-in 401, so that a webmaster publishes the download link of the to-be-uploaded file on a website to provide a download service.

In some embodiments, the instant-publishing management server 402 is configured to generate a download address of the to-be-uploaded file according to related information of the to-be-uploaded file, where the related information of the to-be-uploaded file includes the hash value, a publication timestamp of the to-be-uploaded file, a user identifier of the webmaster that uploads the to-be-uploaded file, and verification information of the to-be-uploaded file. The verification information is generally generated by encrypting a field such as the hash value, the publication timestamp of the to-be-uploaded file, and the user identifier of the webmaster that uploads the to-be-uploaded file. Certainly, the verification information may also be generated in another manner, and the manner of generating the verification information is not limited in this embodiment.

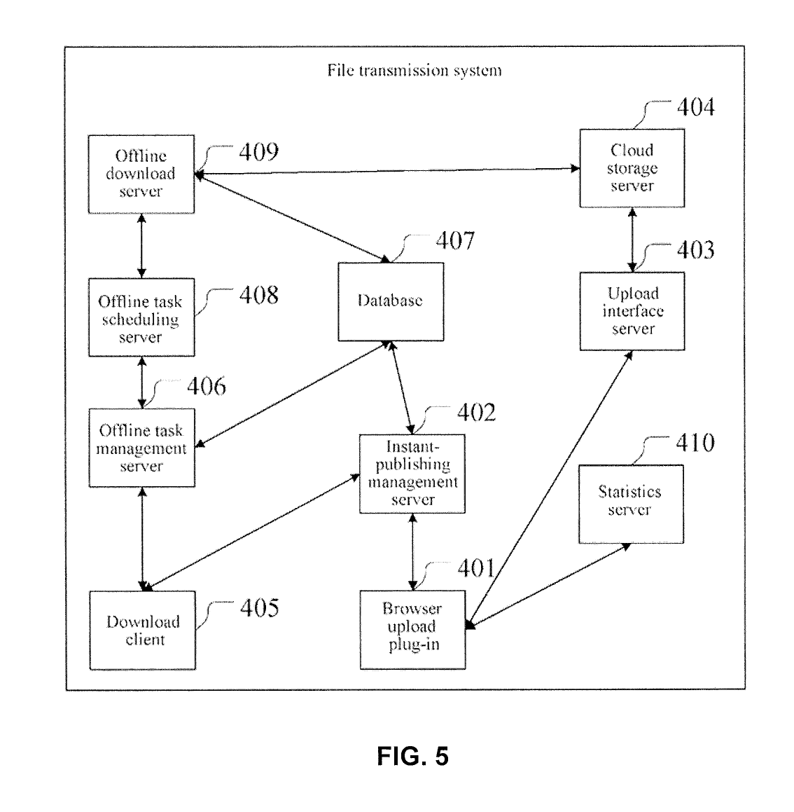

Further, as shown in FIG. 5, the system may further include: an upload interface server 403, a cloud storage server 404, and a download client 405.

The instant-publishing management server 402 is further configured to acquire an upload interface address of the upload interface server 403 when the to-be-uploaded file corresponding to the hash value does not exist in the cloud storage server, and send the upload interface address to the browser upload plug-in 401.

The browser upload plug-in 401 uploads the to-be-uploaded file to the upload interface server 403 according to the upload interface address.

The upload interface server 403 stores the to-be-uploaded file to the cloud storage server 404, so as to provide a download service for the download client 405.

The cloud storage server 404 is configured to store data of a file written by the upload interface server, and provide a service as a data source for the download client 405 or a browser download plug-in 401 to retrieve offline-downloaded data.

The data stored in the cloud storage server 404 may further include data downloaded by an offline download server 409. Further, the system further includes: an offline task management server 406, a database 407, an offline task scheduling server 408, and an offline download server 409.

The offline task management server 406 is configured to receive a task of a to-be-offline-downloaded file sent by the download client 405, and query whether a hash value of the to-be-offline-downloaded file exists in the database 407.

The offline task management server 406 sends, to the download client 405 when the hash value of the to-be-offline-downloaded file exists in the database, a message indicating that the to-be-offline-downloaded file has been downloaded completely, where the message includes an address used for retrieving data of the to-be-offline-downloaded file.

The offline task management server 406 generates a file identifier for the task of the to-be-offline-downloaded file when the hash value of the to-be-offline-downloaded file does not exist in the database, sends the file identifier and the download link of the to-be-offline-downloaded file to the database 407, and sends an offline download task request message to the offline task scheduling server 408, where the offline download task request message includes the task of the to-be-offline-downloaded file and the file identifier.

The offline task scheduling server 408 receives the offline download task request message sent by the offline task management server 406, and schedules the file identifier of the to-be-offline-downloaded file in the offline download task request message to an offline download server 409 having an idle resource in an offline download server cluster.

The offline download server 409 is further configured to receive a file identifier of a to-be-offline-downloaded file sent by an offline download task scheduling server. It should be noted that, the offline download server 409 is an offline download server having an idle resource in the current offline download server cluster.

The offline download server 409 may query, according to the number of the to-be-offline-downloaded file, the database 407 for a download link of the to-be-offline-downloaded file corresponding to the number of the to-be-offline-downloaded file, and download the to-be-offline-downloaded file according to the download link.

The offline download server 409 stores data of the to-be-offline-downloaded file in the cloud storage server 404 when the to-be-offline-downloaded file has been downloaded completely, and stores the hash value of the to-be-offline-downloaded file in the database 407.

The database 407 is configured to store file index information and file attribute information, where the file index information may include a mapping relationship between a file identifier and a download link corresponding to a file, and the file attribute information may include the file identifier, a hash value of the file, a size of the file, the download link of the file, and a download timestamp of the file.

It should be noted that, the system may further include a statistics server 410, and the statistics server 410 is configured to: after the to-be-downloaded file is downloaded completely, receive a download timestamp, a download speed, download reception, a size of the downloaded file, an original link (Uniform/Universal Resource Locator (URL)) of the download, and download speeds and download timestamps acquired from different sources of the download task reported by the download client 405.

This embodiment of the present disclosure provides a file transmission system, where a browser upload plug-in sends a hash value of a to-be-uploaded file to an instant-publishing management server; the instant-publishing management server queries whether the hash value of the to-be-uploaded file exists in a database; and the instant-publishing management server generates a download link of the to-be-uploaded file when the to-be-uploaded file corresponding to the hash value exists in a cloud storage server, and sends the download link of the to-be-uploaded file to the browser upload plug-in, so that a webmaster publishes the download link of the to-be-uploaded file on a website to provide a download service. Therefore, by using this embodiment, a file transmission can be transmitted quickly, and an uploaded file can be shared, so as to accelerate file transmission and publication, and reduce time consumption; and the webmaster can directly publish the obtained download link on a website of the webmaster for users to download, without requiring the webmaster to store file data again, thereby saving storage space.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

What is claimed is:

1. A file transmission method between a client and an instant-publishing management server, comprising:
a browser upload plug-in at the client scanning a to-be-uploaded file, acquiring a unique identifier of the to-be-uploaded file, and sending the unique identifier to the instant-publishing management server;
the instant-publishing management server determining, according to the unique identifier, whether the to-be-uploaded file corresponding to the unique identifier exists in a cloud storage server; and
when the to-be-uploaded file corresponding to the unique identifier exists in the cloud storage server, the instant-publishing management server generating a download link of the to-be-uploaded file and sending the download link of the to-be-uploaded file to the browser upload plug-in, wherein a webmaster is configured to publish the download link of the to-be-uploaded file on a website to provide a download service.

2. The method according to claim 1, wherein the step of the instant-publishing management server generating a download link of the to-be-uploaded file comprises:
generating a download address of the to-be-uploaded file according to related information of the to-be-uploaded file, wherein the related information of the to-be-uploaded file comprises the unique identifier, a publication timestamp of the to-be-uploaded file, a user identifier of the webmaster that uploads the to-be-uploaded file, and verification information of the to-be-uploaded file.

3. The method according to claim 1, further comprising:
when the to-be-uploaded file corresponding to the unique identifier does not exist in the cloud storage server:
the instant-publishing management server acquiring an upload interface address of an upload interface server and sending the upload interface address to the browser upload plug-in;
the browser upload plug-in uploading the to-be-uploaded file to the upload interface server according to the upload interface address; and
the upload interface server storing the to-be-uploaded file in the cloud storage server so as to provide a download service for a download client.

4. The method according to claim 3, wherein data stored in the cloud storage server further comprises data downloaded by an offline download server.

5. The method according to claim 4, wherein the offline download server is further configured to:
receive a file identifier of a to-be-offline-downloaded file sent by an offline download task scheduling server;
query, according to the file identifier, a database for a download link of the to-be-offline-downloaded file corresponding to the file identifier, and download the to-be-offline-downloaded file according to the download link; and
store data of the to-be-offline-downloaded file in the cloud storage server when the to-be-offline-downloaded file is downloaded completely, and store a unique identifier of the to-be-offline-downloaded file in the database.

6. The method according to claim 5, wherein the offline download server is further configured to report a download process of the to-be-downloaded file to an offline task management server, so that the download client views the offline download process.

7. The method according to claim 6, wherein the offline task management server is configured to:
receive a task of a to-be-offline-downloaded file sent by the download client, and query whether a unique identifier of the to-be-offline-downloaded file exists in the database;
send, to the download client, a message indicating that the to-be-offline-downloaded file has been downloaded completely when the unique identifier of the to-be-offline-downloaded file exists in the database, wherein the message comprises an address used for retrieving data of the to-be-offline-downloaded file; and
generate a file identifier for the task of the to-be-offline-downloaded file when the unique identifier of the to-be-offline-downloaded file does not exist in the database, send the file identifier and a download link of the to-be-offline-downloaded file to the database, and send an offline download task request message to the offline task scheduling server, wherein the offline download task request message comprises the task of the to-be-offline-downloaded file and the file identifier.

8. A file transmission system, comprising:
a client including a browser upload plug-in; and
an instant-publishing management server that is communicatively coupled to the client,
wherein:
the browser upload plug-in is configured to scan a to-be-uploaded file, acquire a unique identifier of the to-be-uploaded file, and send the unique identifier to the instant-publishing management server; and
the instant-publishing management server is configured to determine, according to the unique identifier, whether the to-be-uploaded file corresponding to the unique identifier exists in a cloud storage server; and generate a download link of the to-be-uploaded file when the to-be-uploaded file corresponding to the unique identifier exists in the cloud storage server, and send the download link of the to-be-uploaded file to the browser upload plug-in, so that a webmaster publishes the download link of the to-be-uploaded file on a website to provide a download service.

9. The system according to claim 8, wherein the instant-publishing management server is configured to generate a download address of the to-be-uploaded file according to related information of the to-be-uploaded file, wherein the related information of the to-be-uploaded file comprises the unique identifier, a publication timestamp of the to-be-uploaded file, a user identifier of the webmaster that uploads the to-be-uploaded file, and verification information of the to-be-uploaded file.

10. The system according to claim 8, wherein:
the instant-publishing management server is further configured to acquire an upload interface address of an upload interface server when the to-be-uploaded file corresponding to the unique identifier does not exist in the cloud storage server, and send the upload interface address to the browser upload plug-in;
the browser upload plug-in is further configured to upload the to-be-uploaded file to the upload interface server according to the upload interface address; and
the upload interface server is configured to store the to-be-uploaded file in the cloud storage server, so as to provide a download service for a download client.

11. The system according to claim 10, wherein data stored in the cloud storage server further comprises data downloaded by an offline download server.

12. The system according to claim 11, wherein the offline download server is further configured to:
receive a file identifier of a to-be-offline-downloaded file sent by an offline download task scheduling server;
query, according to the file identifier of the to-be-offline-downloaded file, a database for a download link of the to-be-offline-downloaded file corresponding to the number of the to-be-offline-downloaded file, and download the to-be-offline-downloaded file according to the download link; and
store data of the to-be-offline-downloaded file in the cloud storage server when the to-be-offline-downloaded file is downloaded completely, and store a unique identifier of the to-be-offline-downloaded file in the database.

13. The system according to claim 12, wherein the offline download server is further configured to report a download process of the to-be-downloaded file to an offline task management server, so that the download client views the offline download process.

14. The system according to claim 13, wherein the offline task management server is configured to:
receive a task of a to-be-offline-downloaded file sent by the download client, and query whether a unique identifier of the to-be-offline-downloaded file exists in the database;
send, to the download client when the unique identifier of the to-be-offline-downloaded file exists in the database, a message indicating that the to-be-offline-downloaded file has been downloaded completely, wherein the message comprises an address used for retrieving data of the to-be-offline-downloaded file; and
generate a file identifier for the task of the to-be-offline-downloaded file when the unique identifier of the to-be-offline-downloaded file does not exist in the database, send the file identifier and a download link of the to-be-offline-downloaded file to the database, and send an offline download task request message to the offline task scheduling server, wherein the offline download task request message comprises the task of the to-be-offline-downloaded file and the file identifier.

15. The system according to claim 14, wherein the database is configured to store file index information and file attribute information, and the file index information comprises a mapping relationship between a file identifier and a download link corresponding to a file, and the file attribute information comprises the file identifier, a unique identifier of the file, a size of the file, the download link of the file, and a download timestamp of the file.
